(19) United States
(12) Patent Application Publication
(10) Pub. No.: US 2022/0074717 A1
(43) Pub. Date: Mar. 10, 2022

(54) GAS GENERATOR AND FILTER FOR GAS GENERATOR

(71) Applicant: DAICEL CORPORATION, Osaka-shi, Osaka (JP)

(72) Inventor: Koji YAMAMOTO, Tokyo (JP)

(73) Assignee: DAICEL CORPORATION, Osaka-shi, Osaka (JP)

(21) Appl. No.: 17/423,798

(22) PCT Filed: Oct. 24, 2019
(86) PCT No.: PCT/JP2019/041720

§ 371 Date: Jul. 16, 2021

(30) Foreign Application Priority Data
Jan. 17, 2019 (JP) 2019-006162

(51) Int. Cl. F42B 3/04; B01D 46/24; B01D 46/00; B01D 39/20

(52) U.S. Cl. CPC F42B 3/04; B01D 39/2027; B01D 46/0023; B01D 46/2403

(57) ABSTRACT

A gas generator includes a housing, an ignition device, a combustion chamber filled with a gas generating agent, a gas discharge port configured to discharge combustion gas to an outside, and a filter portion disposed between the combustion chamber and the gas discharge port, formed of a metal material, and configured to filter the combustion gas. The filter portion includes a first filter disposed on a side of the combustion chamber and a second filter disposed on a side of the gas discharge port and facing the first filter. The gas generator is provided with a space that is provided between the first filter and the second filter, so as to include a position where the combustion gas flows and to have a predetermined thickness in a direction of flow of the combustion gas, causing a flow rate of the combustion gas flowing into the second filter to decrease due to absence of the metal material.

### FIELD

The present invention relates to a gas generator configured to burn a gas generating agent and generate combustion gas, and a filter for a gas generator.

### BACKGROUND

In a gas generator configured to burn a gas generating agent with which a combustion chamber is filled, thereby generating combustion gas, and to emit the combustion gas to the outside, a filter, for example, is used to filter the combustion gas generated by the burning of the gas generating agent. In Patent Document 1, there is disclosed a filter having a cylindrical shape being disposed in a housing of a gas generator configured to burn a gas generating agent in the housing and discharge combustion gas from a hole formed in the housing. The filter includes a wire mesh layer, a steel wool layer, and a ceramic glass wool layer. In Patent Document 2, there is disclosed a filter formed by layering a plurality of expanded metal sheets and winding the expanded metal sheets into a cylindrical shape.

### CITATION LIST

### [Patent Document]

[Patent Document 1] U.S. Pat. No. 5,533,754

[Patent Document 2] WO 2008/036788

### SUMMARY

### Technical Problem

In a gas generator, combustion residue is collected by a filter as the combustion gas passes through the filter. The filter includes mesh openings of a size sufficient enough to collect the combustion residue. Nevertheless, when the combustion gas passes through a filter including mesh openings of this size, pressure loss increases, causing an increase in a flow rate of the combustion gas. When the flow rate of the combustion gas increases, there is a risk that the combustion residue will pass through the filter and flow out of the filter.

The present disclosure was made in view of the circumstances described above, and an object of the present disclosure is to provide a technique capable of suppressing an outflow of combustion residue to the outside of a filter.

### Solution to Problem

In order to solve the problems described above, according to the present disclosure, a filter portion disposed between a combustion chamber and a gas discharge port, formed of a metal material, and configured to filter a combustion gas includes a first filter disposed on a side of the combustion chamber and a second filter disposed on a side of the gas discharge port and facing the first filter. Then, a configuration is adopted in which the filter portion includes a space including a position where the combustion gas flows between the first filter and the second filter, and having a predetermined thickness in a direction of flow of the combustion gas, causing a flow rate of the combustion gas flowing into the second filter to decrease due to absence of the metal material. With such a configuration, outflow of combustion residue to the outside of the filter (downstream of the second filter) can be suppressed.

Specifically, according to the present disclosure, a gas generator includes a housing, an ignition device accommodated in the housing, a combustion chamber filled with a gas generating agent burned by actuation of the ignition device and provided in the housing, a gas discharge port configured to discharge combustion gas generated by combustion of the gas generating agent to an outside, and a filter portion disposed between the combustion chamber and the gas discharge port, formed of a metal material, and configured to filter the combustion gas. Then, the filter portion includes a first filter disposed on a side of the combustion chamber and a second filter disposed on a side of the gas discharge port and facing the first filter. Further, the gas generator is provided with a space provided between the first filter and the second filter, so as to include a position where the combustion gas flows and to have a predetermined thickness in a direction of flow of the combustion gas, causing a flow rate of the combustion gas flowing into the second filter to decrease due to absence of the metal material therein.

The space substantially eliminates a air-flow resistance due to the absence of the metal material, making it possible to substantially eliminate a pressure loss in the space and reduce the flow rate of the combustion gas. Here, the predetermined thickness of the space is a distance sufficient enough to reduce the flow rate of the combustion gas to the extent that the combustion residue does not flow out of the filter portion. Therefore, the first filter and the second filter constituting the filter portion are disposed adjacent to each other in a flow path through which the gas flows. For example, the first filter is disposed upstream of a flow path of the combustion gas, and the second filter is disposed downstream of the flow path. The space is formed in at least a portion of a region formed between the first filter and the second filter facing each other. Thus, the combustion gas passes through the first filter, enters the second filter via the space, and is discharged from the second filter. Note that the filter portion may be a single unit (filter unit) including the first filter, the second filter, and the space, that is, a member that can be handled as one assembly. The predetermined thickness of the space is, for example, a distance between the first filter and the second filter. The space substantially eliminates an air-flow resistance due to the absence of the metal material, making it possible to substantially eliminate the pressure loss in the space portion and reduce the flow rate of the combustion gas. Further, the filter portion may be disposed at any position in the flow path of the combustion gas from the combustion chamber to the gas discharge port.

The gas generator filters the combustion gas generated after actuation of the ignition device by the filter portion. As the first filter and the second filter of the filter portion collect combustion residue, a mesh opening portion is gradually filled with combustion residue, and the pressure loss of the combustion gas gradually increases. When the pressure loss increases, the flow rate of the combustion gas increases. However, because the gas generator is provided with the space, the flow rate of the combustion gas in the space can be reduced, and the flow rate of the combustion gas flowing into the second filter can be reduced. By reducing the flow rate of the combustion gas flowing into the second filter, it is possible to reduce the flow rate of the combustion gas when passing through the second filter. As a result, the gas generator can suppress the outflow of the combustion residue once collected by the second filter to the outside of the filter portion (downstream of the second filter). Furthermore, in the gas generator, even if the combustion residue once collected by the first filter passes through the first filter, the flow rate of the combustion gas in the space is reduced, making it possible to collect this combustion residue by the second filter. In this way, the gas generator can suppress the outflow of combustion residue to the outside of the filter portion.

In the gas generator described above, the first filter may be cylindrical and disposed including the combustion chamber in an interior thereof, the second filter may be cylindrical and disposed sandwiching the space and including the first filter in an interior thereof, and the first filter and the second filter may be interposed between a first wall and a second wall facing each other from opposite sides in an axial direction. According to the gas generator provided with this configuration, the combustion gas that has passed through the first filter and the second filter can be discharged from the gas discharge port. Further, according to this gas generator, the combustion residue is collected by the first filter and the second filter, and the flow rate of the combustion gas flowing into the second filter can be reduced by the space, making it possible to suppress the outflow of the combustion residue to the outside of the filter portion.

In the gas generator described above, the space may be positioned including at least an area between a first imaginary straight line connecting a gas generating agent near the first wall inside the combustion chamber and the gas discharge port, and a second imaginary straight line connecting a gas generating agent near the second wall inside the combustion chamber and the gas discharge port. The space may be provided at a position where a relatively large amount of combustion gas flows. It can be assumed that the combustion gas generated by the combustion of the gas generating agent near the first wall flows substantially linearly toward the gas discharge port, and the combustion gas generated by the combustion of the gas generating agent near the second wall flows substantially linearly toward the gas discharge port. Therefore, the space may be positioned including at least the area between the first imaginary straight line connecting the gas generating agent near the first wall and the gas discharge port and the second imaginary straight line connecting the gas generating agent near the second wall inside the combustion chamber and the gas discharge port. In this way, the gas generator with the space disposed therein can reduce the flow rate of the combustion gas flowing into the second filter. As a result, this gas generator can suppress the outflow of combustion residue to the outside of the filter portion.

In the gas generator described above, the space may be formed enclosed by the first filter, the second filter, the first wall, and the second wall. For example, the space may be a space defined by the first filter, the second filter, the first wall, and the second wall. As a result, this gas generator can cause the combustion gas that passes through the space to flow into the second filter and reduce the flow rate of the combustion gas flowing into the second filter, making it possible to suppress the outflow of the combustion residue to the outside of the filter portion.

In the gas generator described above, the first filter and the second filter may be formed by layering a filter material having a same thickness across a plurality of layers in the direction of flow of the combustion gas, and a thickness of the space may be greater than or equal to a thickness of one layer of the filter material. According to the gas generator provided with this configuration, even if irregularities occur in the pressure loss in each layer of the first filter, the flow rate of the combustion gas flowing into the space through the first filter can be reduced. This makes it possible to reduce the flow rate of the combustion gas flowing into the second filter. As a result, this gas generator can suppress the outflow of combustion residue to the outside of the filter portion.

In the gas generator described above, the filter portion may include a spacer interposed between the first filter and the second filter and configured to maintain the space at the predetermined thickness. The gas generator provided with this configuration can maintain the predetermined thickness of the space. As a result, this gas generator can maintain the thickness of the space at a predetermined thickness sufficient enough to reduce the flow rate of the combustion gas and, by reducing the flow rate of the combustion gas flowing into the second filter in the space, can suppress the outflow of the combustion residue to the outside of the filter portion.

In the gas generator described above, the first filter, the second filter, and the spacer may be integrally formed of the metal material. For example, the filter portion may be formed by compressing, in a radial direction and an axial direction, the metal material wound into a cylindrical shape in a longitudinal direction. The spacer is provided to maintain the space and, by preventing the first filter from being deformed and the space from being crushed when the combustion gas passes through the filter portion, for example, can maintain the predetermined thickness of the space. This makes it possible to cover, with the spacer, a range of from 5% to 50% of an entire surface of the first filter on the downstream side or an entire surface of the second filter on the upstream side facing each other.

In the gas generator described above, a mesh opening of the second filter may be smaller than a mesh opening of the first filter. According to the gas generator provided with this configuration, the space can be provided inward of the second filter having a relatively small mesh opening and, by reducing the flow rate of the combustion gas flowing into the second filter, can suppress the outflow of the combustion residue once collected by the second filter having a small mesh opening to the outside of the filter portion.

Here, the present disclosure can be considered from an aspect of a filter for a gas generator. That is, the present disclosure is a filter for a gas generator. Specifically, the filter is a filter for a gas generator including a housing, an ignition device accommodated in the housing, a combustion chamber filled with a gas generating agent burned by actuation of the ignition device and provided in the housing, and a gas discharge port configured to discharge combustion gas generated by combustion of the gas generating agent to an outside. The filter is disposed between the combustion chamber and the gas discharge port, formed of a metal material, and configured to filter the combustion gas. Then, the filter according to the present disclosure includes a first filter disposed on a side of the combustion chamber, a second filter disposed on a side of the gas discharge port and facing the first filter, a space being provided between the first filter and the second filter, so as to include a position where the combustion gas flows and to have a predetermined thickness in a direction of flow of the combustion gas, causing a flow rate of the combustion gas flowing into the second filter to decrease due to absence of the metal material therein when disposed in the housing, and a spacer interposed between the first filter and the second filter, and configured to maintain the space at the predetermined thickness.

### Advantageous Effects of Invention

According to the technique of the present disclosure, it is possible to suppress outflow of combustion residue to the outside of a filter.

### BRIEF DESCRIPTION OF DRAWINGS

FIG. 1 is a view illustrating a schematic configuration of a gas generator according to a first example.

FIG. 2 is a view illustrating the gas generator according to the first example.

FIG. 3 is a view illustrating the gas generator according to a second example.

FIG. 4 is a view illustrating the gas generator according to a third example.

FIG. 5 is a view illustrating a filter for a gas generator according to a fourth example.

FIG. 6 is a view illustrating a filter material used in manufacture of the filter for a gas generator according the fourth example.

FIG. 7 is a view illustrating a schematic configuration of a gas generator according to a fifth example.

### DESCRIPTION OF EMBODIMENTS

A gas generator according to an embodiment of the present disclosure will be described below with reference to the drawings. Note that each of the configurations, combinations thereof, and the like in each embodiment is an example, and various additions, omissions, substitutions, and other changes may be made as appropriate without departing from the spirit of the present invention. The present invention is not limited by the embodiments and is limited only by the claims.

### First Example

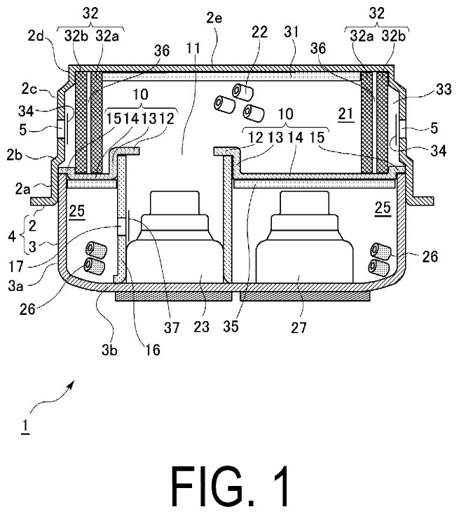

FIG. 1 is a cross-sectional view in a height direction of a gas generator 1 according to a first example. The gas generator 1 is configured to burn a gas generating agent with which a housing 4, formed by an upper shell 2 and a lower shell 3, is filled and to release a combustion gas. Note that the gas generator 1 is a so-called dual-type gas generator including two combustion chambers disposed on an upper side and a lower side, respectively, and each of the two combustion chambers includes an igniter and a gas generating agent corresponding thereto, as described below. The upper shell 2 includes a large diameter peripheral wall 2c, a small diameter peripheral wall 2d, and a top surface 2e, which form an internal space having a concave shape. The top surface 2e, together with a bottom surface 3b of the lower shell 3 described later, has a substantially circular shape in a top view. The large diameter peripheral wall 2c and the small diameter peripheral wall 2d surround a periphery of the top surface 2e, and form a wall surface having an annular shape and extending substantially perpendicularly from the top surface 2e. The internal space of the upper shell 2 is a space containing a first gas generating agent 22 as described below. The top surface 2e is connected to a first end side (upper side in FIG. 1) of the small diameter peripheral wall 2d, and the large diameter peripheral wall 2c having a diameter greater than that of the small diameter peripheral wall 2d is connected to a second end side (lower side in FIG. 1) thereof. A radius of an internal space formed by the large diameter peripheral wall 2c is greater than a radius of an internal space formed by the small diameter peripheral wall 2d. Further, a second end side (lower side in FIG. 1) of the large diameter peripheral wall 2c serves as an opening of the upper shell 2. Then, on the second end side of the large diameter peripheral wall 2c, a mating wall 2a and an abutting portion 2b are provided in this order from the opening. A radius of an internal space formed by the mating wall 2a is greater than a radius of an internal space formed by the large diameter peripheral wall 2c, and the mating wall 2a connects to the large diameter peripheral wall 2c with the abutting portion 2b interposed therebetween.

The lower shell 3 includes a peripheral wall 3a and the bottom surface 3b which form an internal space having a concave shape. The internal space is a second combustion chamber 25 filled with a second gas generating agent 26. The bottom surface 3b is connected to a first end side of the peripheral wall 3a, and a second end side thereof serves as an opening of the lower shell 3. Then, the radius of the internal space formed by the peripheral wall 3a is substantially the same as the radius of the internal space formed by the large diameter peripheral wall 2c of the upper shell 2. The bottom surface 3b of the lower shell 3 is provided with a hole in which a first igniter 23 is fixed and a hole in which a second igniter 27 is fixed.

Further, in the housing 4, a divider wall 10 is disposed between the upper shell 2 and the lower shell 3. The divider wall 10 includes a terminating end 15, a dividing wall 14 connected to the terminating end 15 and substantially dividing the inside of the housing 4 into upper and lower spaces, a peripheral wall 13 connected to the dividing wall 14 and extending along an accommodating wall member (accommodating wall) 16 described later, and an end 12 disposed partially covering the opening of the accommodating wall member 16. Note that the end 12 forms a through hole 11. Further, the accommodating wall member 16 having a tubular shape is provided on the bottom surface 3b, surrounding the periphery of the first igniter 23 attached to the bottom surface 3b of the lower shell 3 in the height direction thereof. An opening above the accommodating wall member 16 is covered by the end 12 of the divider wall 10. In addition, a through hole 17 is provided in the accommodating wall member 16, and the through hole 17 allows communication between two spaces (a first combustion chamber 21 and the second combustion chamber 25) resulting from division by the divider wall 10. Note that, before actuation of the second igniter 27, the through hole 17 is closed by an aluminum tape 37 from the side where the first igniter 23 is arranged.

An interior of the accommodating wall member 16 having a tubular shape and surrounding the first igniter 23 may be filled with a transfer charge. Examples of the transfer charge include a granular or cylindrical transfer charge containing, for example, nitroguanidine (34 wt. %) and strontium nitrate (56 wt. %). Further, when the interior is filled with the transfer charge, the through hole 11 is closed by aluminum tape or the like, and mixture of the transfer charge and the first gas generating agent 22 is prevented. The gas generator 1 according to the present example includes the first igniter 23 as an ignition device. The ignition device may be constituted by the first igniter 23 only, or may be configured to include the first igniter 23 and the transfer charge.

In a state in which the divider wall 10 is thus attached on the lower shell 3, the upper shell 2 is further attached from above. As described above, since the radius of the internal space formed by the mating wall 2a of the upper shell 2 is larger than the radius of the internal space formed by the large diameter peripheral wall 2c, the upper shell 2 is mated with the lower shell 3, and thus the abutting portion 2b is abutted on the terminating end 15 of the divider wall 10. Note that, in the housing 4, at a site of mating or contact between the upper shell 2 and the lower shell 3, the upper shell 2 and the lower shell 3 are joined by any joining method (for example, welding) suitable in terms of moisture prevention and the like for the gas generating agent filled in the housing 4.

As described above, the internal space of the housing 4 is substantially divided, by the divider wall 10, into two spaces positioned on the upper side and the lower side, respectively. In the internal space of the housing 4, the first igniter 23 and the first gas generating agent 22 are disposed in the first combustion chamber 21, and the second igniter 27 and the second gas generating agent 26 are disposed in the second combustion chamber 25. In this way, the gas generator 1 is configured as a dual-type gas generator including two igniters, that is, the first igniter 23 and the second igniter 27. Note that the first igniter 23 and the second igniter 27 are both fixed on the bottom surface 3b of the lower shell 3, and thus the first igniter 23 is housed in a state in which the side of the first igniter 23 is surrounded by the accommodating wall member 16. Note that the first igniter 23 need only be disposed inside the housing 4, and thus the first gas generating agent 22 can be burned. Similarly, the second igniter 27 need only be disposed inside the housing 4, and thus the second gas generating agent 26 can be burned.

In the first combustion chamber 21, the first igniter 23 is accommodated in the internal space of the accommodating wall member 16 (the space defined by an inner side of the accommodating wall member 16 and the bottom surface 3b of the lower shell 3 and opening upward), and the space thereabove is filled with the first gas generating agent 22. Further, a plurality of gas discharge ports 5 configured to discharge combustion gas generated by the combustion of the gas generating agents 22, 26 to the outside are provided in the large diameter peripheral wall 2c in the circumferential direction of the large diameter peripheral wall 2c. Each gas discharge port 5 communicates the inside with the outside of the housing 4. To prevent moisture from entering the housing 4 from the outside, before actuation of the gas generator 1, the gas discharge port 5 is closed by an aluminum tape 34 from the interior of the housing 4.

Further, the gas generator 1 is provided with a filter portion 32 between the first combustion chamber 21 and the gas discharge port 5, which is formed of a metal material and configured to filter the combustion gas. The filter portion 32 has a cylindrical shape open on both sides in the axial direction as a whole, is disposed in the housing 4, and thus includes the first combustion chamber 21 in an interior of the cylindrical shape. The filter portion 32 includes a first filter 32a disposed on a side of the combustion chamber 21 and a second filter 32b disposed on a side of the gas discharge port 5 and facing the first filter 32a. The first filter 32a is cylindrical and disposed including the first combustion chamber 21 in an interior thereof. The second filter 32b is cylindrical and disposed sandwiching a space 36 and including the first filter 32a in an interior thereof. The first filter 32a and the second filter 32b are interposed between the top surface 2e (corresponding to “first wall”) and the dividing wall 14 (corresponding to “second wall”) that face each other from both sides in the axial direction. Therefore, the combustion gas generated in the first combustion chamber 21 and the second combustion chamber 25 passes through the first filter 32a and the second filter 32b, and then reaches the gas discharge port 5. The first filter 32a and the second filter 32b are formed by, for example, radially overlapping a stainless steel flat wire mesh, lath metal, or expanded metal in the radial direction and compressing the layers in the radial direction and the axial direction. Alternatively, filters having a wire-wound-type structure, in which a wire is wound forming multiple layers on a core rod, may be used as the first filter 32a and the second filter 32b. Further, the space 36 in which the metal material that forms the first filter 32a and the second filter 32b is absent is formed between the first filter 32a and the second filter 32b. The space 36 is formed surrounded by the first filter 32a, the second filter 32b, and the top surface 2e, and the dividing wall 14. The first filter 32a, the space 36, and the second filter 32b are disposed substantially concentrically in this order from the inner side. Note that the space 36 will be described in detail later.

The filter portion 32 cools the combustion gas by the first gas generating agent 22, and collects (filters) the combustion residue. Note that the filter portion 32 also collects the combustion residue of the second gas generating agent 26 filled in the second combustion chamber 25. Further, as illustrated in FIG. 1, a gap 33 formed between the large diameter peripheral wall 2c of the upper shell 2 and the filter portion 32 forms a gas passage that surrounds the filter portion 32 and has an annular shape in the radial direction in cross sectional view. This gap 33 allows the combustion gas to pass through the entire area of the filter portion 32, and thus it is possible to achieve effective utilization of the filter portion 32 and effective cooling and filtering (purification) of the combustion gas. The combustion gas flowing through the gap 33 reaches the gas discharge port 5 provided in the large diameter peripheral wall 2c.

Further, a cushion 31 is disposed in the first combustion chamber 21. The cushion 31 is formed of a material that elastically deforms or plastically deforms, and imparts a biasing force to the first gas generating agent 22 filled in the first combustion chamber 21. The first gas generating agent 22 is filled in a state of being pressed against the first filter 32a, the dividing wall 14, and the like by the biasing force of the cushion 31 and thus does not vibrate unnecessarily inside the first combustion chamber 21. The first gas generating agent 22 used is a gas generating agent having a relatively low combustion temperature. It is preferable that the first gas generating agent 22 has a combustion temperature in the range of from 1000 to 1700° C. As the first gas generating agent 22, a single hole cylindrical gas generating agent including guanidine nitrate (41 wt. %), basic copper nitrate (49 wt. %), and a binder and an additive, for example, may be used. Note that the internal space of the accommodating wall member 16 may be filled with a gas generating agent having a different composition from that of the first gas generating agent 22. In this case, the composition of the gas generating agent filled in the internal space of the accommodating wall member 16 can be configured with the combustion temperature higher than the combustion temperature of the first gas generating agent 22 to promote ignition of the first gas generating agent 22.

Further, the second combustion chamber 25 is filled with the second gas generating agent 26 correspondingly to the second igniter 27 fixed to the bottom surface 3b of the lower shell 3. Further, a cushion 35 is disposed in the second combustion chamber 25. The cushion 35 is formed of a material that elastically deforms or plastically deforms, and imparts a biasing force to the second gas generating agent 26 filled in the second combustion chamber 25. In this way, the second gas generating agent 26 is also filled in a state of being biased by the cushion 35 and thus does not vibrate unnecessarily inside the second combustion chamber 25. Further, similar to the first gas generating agent 22, for the second gas generating agent 26 as well, a single hole cylindrical gas generating agent including guanidine nitrate (41 wt. %), basic copper nitrate (49 wt. %), and a binder and an additive, for example, may be used.

A resin material such as ethylene propylene diene rubber or silicon rubber, an inorganic material such as ceramic fibers, or a metal based material such as a knitted wire mesh is used for the cushions 31, 35. Note that the cushions 31, 35 may be formed of a material that does not elastically deform or plastically deform and does not readily burn or does not generate inconvenient gases even when burned.

In addition, an area surrounding the second igniter 27 may be filled with a transfer charge. Examples of the transfer charge include a granular or cylindrical transfer charge containing, for example, nitroguanidine (34 wt. %) and strontium nitrate (56 wt. %). In addition, when the area is filled with a transfer charge, a predetermined member that isolates the transfer charge and the second gas generating agent 26 is arranged, and thus the transfer charge and the second gas generating agent 26 are not mixed. The gas generator 1 according to the present example includes the second igniter 27 as an ignition device. The ignition device may be constituted by the second igniter 27 only, or may be configured to include the second igniter 27 and the transfer charge.

With such a configuration, in the gas generator 1, the release mode of the combustion gas to the outside can be variously adjusted by the combustion of the first gas generating agent 22 caused by actuation of the first igniter 23 and combustion of the second gas generating agent 26 caused by actuation of the second igniter 27. Further, the gas generator 1 can also generate and release, to the outside, a relatively large amount of combustion gas.

Next, the operation of the gas generator 1 and the details of the space 36 according to the present example will be described with reference to FIG. 1. First, in the gas generator 1, the first igniter 23 is actuated, causing the first gas generating agent 22 inside the first combustion chamber 21 to burn. As a result, combustion gas is generated inside the first combustion chamber 21, and the pressure inside the first combustion chamber 21 rises. Due to the rise in pressure inside the first combustion chamber 21, the aluminum tape 34 that closes the gas discharge ports 5 raptures, and the inside and the outside of the housing 4 are communicated by the gas discharge ports 5. The combustion gas generated by the first gas generating agent 22 reaches the gas discharge ports 5 through the filter portion 32, and is supplied to the outside of the gas generator 1 though the gas discharge ports 5.

Next, the second igniter 27 is actuated, causing the second gas generating agent 26 inside the second combustion chamber 25 to burn. As a result, combustion gas is generated inside the second combustion chamber 25, and the pressure inside the second combustion chamber 25 rises. Due to the rise in pressure inside the second combustion chamber 25, the aluminum tape 37 that closes the through holes 17 raptures, and the first combustion chamber and the second combustion chamber are communicated. The combustion gas generated by the second gas generating agent 26 reaches the gas discharge ports 5 through the through holes 17, the first combustion chamber 21, and the filter portion 32, and is supplied to the outside of the gas generator 1 though the gas discharge ports 5. Thus, the gas generator 1 can release the combustion gas to the outside by the combustion of the first gas generating agent 22 by actuation of the first igniter 23 and the combustion of the second gas generating agent 26 by actuation of the second igniter 27. Note that, the actuation timing of each igniter is determined in accordance with the output characteristics of the combustion gas required for the gas generator 1.

Here, the space 36 is disposed between the first filter 32a and the second filter 32b, and thus includes a position where the combustion gas flows. The first filter 32a includes mesh openings of a size sufficient enough to collect the combustion residue. When the combustion gas passes through the first filter 32a, the combustion residue is collected, but the pressure loss increases, causing an increase in the flow rate. The space 36 has a predetermined thickness in a direction of flow of the combustion gas, causing the flow rate of the combustion gas flowing into the second filter 32b to decrease due to absence of the metal material forming the first filter 32a and the second filter 32b. Here, the predetermined thickness is a distance between the first filter 32a and the second filter 32b and is sufficient enough to reduce the flow rate of the combustion gas to the extent that the combustion residue does not flow out of the second filter 32b. The space 36 substantially eliminates an air-flow resistance due to the absence of the metal material, making it possible to substantially eliminate the pressure loss and reduce the flow rate of the combustion gas. The first filter 32a and the second filter 32b constituting the filter portion 32 are disposed adjacent to each other in the flow path through which the gas flows. For example, the first filter 32a is disposed upstream of a flow path of the combustion gas, and the second filter 32b is disposed downstream of the flow path. The space 36 is formed in at least a portion of a region formed between the first filter and the second filter facing each other. Thus, the combustion gas passes through the first filter 32a, enters the second filter 32b via the space 36, and is discharged from the second filter 32b. Note that the filter portion 32 may be a single unit (filter unit) including the first filter 32a, the second filter 32b, and the space 36, that is, a member of a unit that can be handled as one assembly. Note that the metal material being absent in the space 36 means that the metal material constituting the first filter 32a and the second filter 32b is absent in the space 36. Furthermore, the space 36 does not include a region where the mesh opening portion (openings) of the filter are formed by overlapping.

The gas generator 1 collects the combustion residue generated after actuation of the first igniter 23 by the filter portion 32. As the first filter 32a and the second filter 32b of the filter portion 32 collect combustion residue, the mesh opening portion is gradually filled with combustion residue, and the pressure loss of the combustion gas gradually increases. When the pressure loss increases, the flow rate of the combustion gas increases. However, because the gas generator 1 according to the present example includes the space 36, the flow rate of the combustion gas flowing into the second filter 32b in the space 36 can be reduced. By reducing the flow rate of the combustion gas flowing into the second filter 32b, it is possible to reduce the flow rate of the combustion gas when passing through the second filter 32b. As a result, the gas generator 1 can suppress the outflow of the combustion residue once collected by the second filter 32b to the outside of the filter portion 32. Furthermore, even if the combustion residue once collected by the first filter 32a passes through the first filter 32a and flows to the space 36, the flow rate of the combustion gas in the space 36 is reduced, making it possible to collect this combustion residue by the second filter 32b. In this way, the gas generator 1 according to the present example can suppress the outflow of combustion residue to the outside of the filter portion 32.

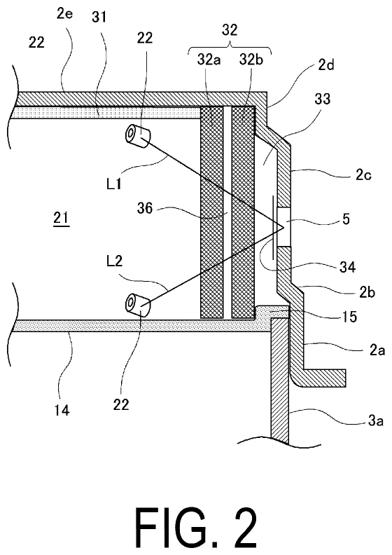

The space 36 may be provided at a position where a relatively large amount of combustion gas flows. FIG. 2 is an enlarged cross-sectional view illustrating the vicinity of the filter portion 32 and the gas discharge port 5 of the gas generator 1 illustrated in FIG. 1. For example, as illustrated in FIG. 2, it can be assumed that the combustion gas generated by the combustion of the first gas generating agent 22 near the top surface 2e flows substantially linearly toward the gas discharge port 5, and the combustion gas generated by the combustion of the first gas generating agent 22 near the dividing wall 14 flows substantially linearly toward the gas discharge port 5. Therefore, the space 36 may be positioned including at least the area between a first imaginary straight line L1 connecting the gas generating agent 22 near the top surface 2e inside the first combustion chamber 21 and the gas discharge port 5, and a second imaginary straight line L2 connecting the first gas generating agent 22 near the dividing wall 14 inside the first combustion chamber 21 and the gas discharge port 5. In this way, the gas generator 1 with the space 36 disposed therein can, with the space 36 disposed at a position where the combustion gas passes, reduce the flow rate of the combustion gas flowing into the second filter 32b. As a result, this gas generator 1 can suppress the outflow of combustion residue to the outside of the filter portion 32.

Further, in the gas generator described in Patent Document 1 described above, a metal wire is spirally wound around a steel wool layer of an outermost layer of the filter, forming a gap between the filter and the housing. The steel wool layer is partially covered by this metal wire, and thus irregularities occur in the mesh openings of the steel wool layer. As a result, irregularities occur in the pressure loss in the filter described in Patent Document 1 and, in a region where the pressure loss becomes relatively large inside this filter, the flow rate of the combustion gas increases, resulting in the risk that combustion residue may flow outside of the filter by the combustion gas. Further, in Patent Document 1, a gap is formed between the housing and the filter rather than between two filters, and thus it is conceivably difficult to collect residue flowing into the gap due to a rise in the flow rate of the combustion gas generated upstream of the gap. On the other hand, because the gas generator 1 according to the present example includes the space 36, the flow rate of the combustion gas flowing into the second filter 32b can be reduced. As a result, the gas generator 1 reduces the flow rate of the combustion gas in the space 36 even when the pressure loss inside the first filter 32a increases, making it possible to suppress the outflow of combustion residue to the outside of the filter portion 32.

Furthermore, the mesh opening of the second filter 32b may be smaller than the mesh opening of the first filter 32a. As a result, the space 36 can be provided inward of the second filter 32b having a relatively small mesh opening and, by reducing the flow rate of the combustion gas flowing into the second filter 32b, can suppress the outflow of the combustion residue once collected by the second filter 32b having a small mesh opening to the outside of the filter portion 32.

### Second Example

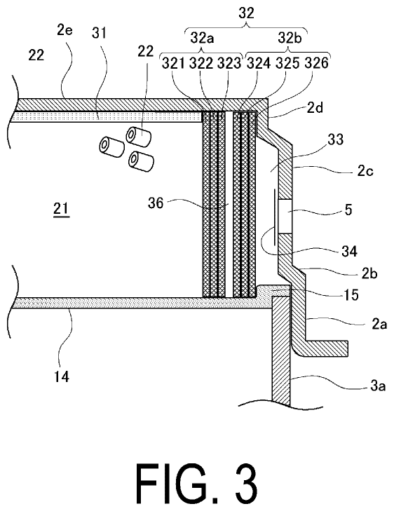

Next, the gas generator 1 according to a second example will be described using FIG. 3. In the gas generator 1 according to the present example, the first filter 32a and the second filter 32b of the filter portion 32 have a layered structure, but otherwise the gas generator 1 has the same configuration as the gas generator 1 according to the first example described above.

FIG. 3 is an enlarged cross-sectional view illustrating the vicinity of the filter portion 32 and the gas discharge port 5 of the gas generator 1 according to the present example. The first filter 32a includes the filter materials 321, 322, 323 layered from the first combustion chamber 21 in the direction of the gas discharge port 5. Similarly, the second filter 32b includes filter materials 324, 325, 325 layered from the first combustion chamber 21 in the direction of the gas discharge port 5. The direction from the first combustion chamber 21 toward the gas discharge port 5 is the direction in which the combustion gas flows. The first filter 32a and the second filter 32b are formed by layering the filter materials 321 to 325 having substantially the same thickness across a plurality of layers in the direction of flow of the combustion gas.

In the gas generator described in Patent Document 1, filter materials formed of the different materials of a wire mesh layer, a steel wool layer, and a ceramic glass wool layer are layered. In a filter in which a plurality of filter materials formed of different materials are layered, the size and the position of the mesh openings in each layer differ, causing irregularities to occur in each layer in terms of the pressure loss that occurs when the combustion gas passes through the filter. Further, the filter described in Patent Document 2 is formed by layering a plurality of expanded metal sheets. A plurality of openings are formed in this expanded metal sheet and, in the filter described in Patent Document 2, the plurality of expanded metal sheets must be layered by being positioned with the openings formed in each of the expanded metal sheets overlapping. In this case, when the openings formed in each layer are shifted, irregularities occur in each layer in terms of the pressure loss that occurs when the combustion gas passes through the filter. In a region where the pressure loss inside the filter becomes relatively large, the flow rate of the combustion gas increases, and there is a risk that the combustion residue once collected by the filter may flow out of the filter. Thus, in the layered filter in the related art, the combustion residue may flow out of the filter.

On the other hand, the gas generator 1 according to the present example includes the first filter 32a and the second filter 32b in which a plurality of layers are layered, and the space 36 formed between the first filter 32a and the second filter 32b. Therefore, even if irregularities occur in the pressure loss in each layer of the filter materials 321, 322, 323 of the first filter 32a, the flow rate of the combustion gas flowing into the space 36 through the first filter 32a can be reduced. Therefore, the flow rate of the combustion gas flowing into the second filter 32b can be reduced. By reducing the flow rate of the combustion gas flowing into the second filter 32b, the gas generator 1 according to the present example can suppress the outflow of the combustion residue once collected by the second filter 32b to the outside of the filter portion 32. Furthermore, even if the combustion residue once collected by the first filter 32a passes through the first filter 32a and flows to the space 36, the flow rate of the combustion gas in the space 36 is reduced, making it possible to collect this combustion residue by the second filter 32b. In this way, the gas generator 1 according to the present example can suppress the outflow of combustion residue to the outside of the filter portion 32.

### Third Example

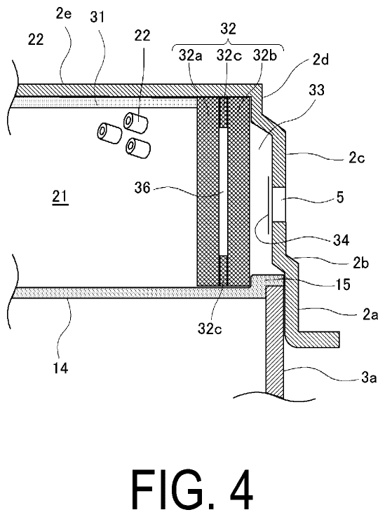

Next, the gas generator 1 according to a third example will be described using FIG. 4. In the gas generator 1 according to the present example, the filter portion 32 includes a spacer 32c, but otherwise the gas generator 1 has the same configuration as the gas generator 1 according to the first example described above.

FIG. 4 is an enlarged cross-sectional view illustrating the vicinity of the filter portion 32 and the gas discharge port 5 of the gas generator 1 according to the present example. In the gas generator 1 according to the present example, the filter portion 32 includes the spacer 32c interposed between the first filter 32a and the second filter 32b and configured to maintain the space 36 at the predetermined thickness. In the present example, the spacer 32c is provided on both ends of the filter portion 32 in the axial direction. The spacer 32c may be provided only on one side in the axial direction, or may be provided between both ends. The first filter 32a, the second filter 32b, and the spacer 32c may be integrally formed of the same metal material.

The gas generator 1 according to the present example includes the spacer 32c, and thus the predetermined thickness of the space 36 can be maintained. Thus, the gas generator 1 according to the present example reduces the flow rate of the combustion gas flowing into the second filter 32b inside the space 36, and can thus suppress the outflow of combustion residue to the outside of the filter portion 32. The spacer 32c can be separated from the first filter 32a and the second filter 32b in the radial direction (layering direction) before being disposed between the first filter 32a and the second filter 32b, and is interposed between the first filter 32a and the second filter 32b when the first filter 32a, the space 32c, and the second filter 32b are layered in the radial direction. This makes it easy to form the filter portion 32. After the spacer 32c is disposed between the first filter 32a and the second filter 32b, the spacer 32c may of course be welded and fixed to the second filter 32b. Further, the spacer 32c is provided for maintaining the space 36 and, by preventing the first filter 32a from being deformed and the space 36 from being crushed when the combustion gas passes through the filter portion 32, for example, can maintain the predetermined thickness of the space 36. Therefore, it is possible to cover, with the spacer 32c, a range of from 5% to 50% of the entire surface of the first filter 32a on the downstream side or the entire surface of the second filter 32b on the upstream side facing each other.

### Fourth Example

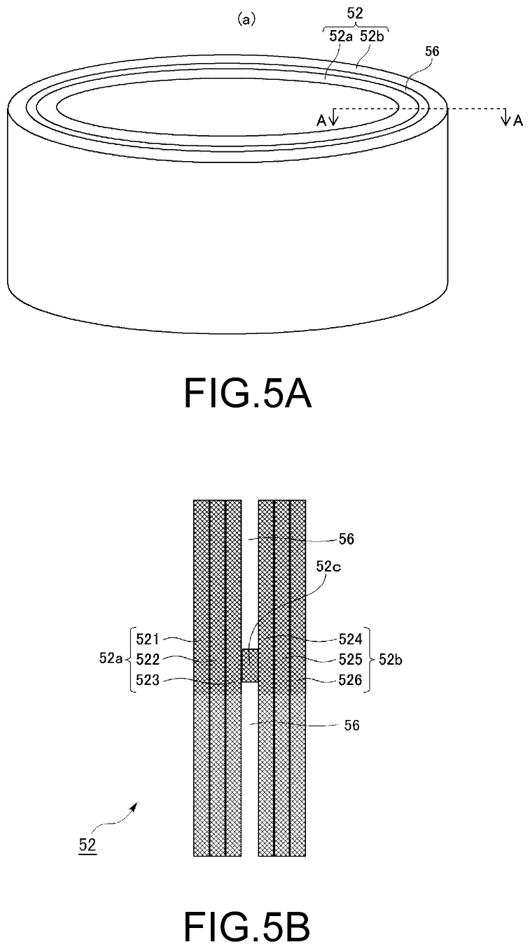

Next, a filter 52 for a gas generator according to a fourth example will be described using FIG. 5. The filter 52 according to the present example can be used in the gas generators according to the first to third examples and the fifth example described later. Specifically, the filter 52 is a filter for a gas generator including a housing, an ignition device accommodated in the housing, a combustion chamber filled with a gas generating agent burned by actuation of the ignition device and provided in the housing, and a gas discharge port configured to discharge combustion gas generated by combustion of the gas generating agent to the outside. The filter is disposed between the combustion chamber and the gas discharge port, formed of a metal material, and configured to filter the combustion gas.

FIG. 5(a) is an external perspective view of the filter 52. The filter 52 has a cylindrical shape open on both sides in the axial direction as a whole, is disposed in the housing, and thus includes the combustion chamber in an interior of the cylindrical shape. The filter 52 includes a first filter 52a disposed on a side of the combustion chamber and a second filter 52b disposed on a side of the gas discharge port and facing the first filter 52a. Then, the filter 52 further includes a space 56 provided between the first filter 52a and the second filter 52b, so as to include a position where the combustion gas flows and to have a predetermined thickness in a direction of flow of the combustion gas, causing a flow rate of the combustion gas flowing into the second filter 52b to decrease due to absence of the metal material forming the first filter 52a and the second filter 52b when disposed in the housing.

FIG. 5(b) is a cross-sectional view of the filter 52 in the axial direction with the filter 52 cut along line A-A illustrated in FIG. 5(a). The first filter 52a includes filter materials 521, 522, 523 layered from in the direction of flow of the combustion gas. Similarly, the second filter 52b includes filter materials 524, 525, 526 layered in the direction of flow of the combustion gas. The first filter 52a and the second filter 52b are formed by layering the filter materials 521 to 526 having substantially the same thickness across a plurality of layers in the direction of flow of the combustion gas.

Further, the filter 52 includes a spacer 52c interposed between the first filter 52a and the second filter 52b and configured to maintain the space 56 at the predetermined thickness. The spacer 52c may be integrally formed of the same metal material with the first filter 52a and the second filter 52b. Note that the spacer 52c may be disposed between the first filter 52a and the second filter material 52b after being formed separately from the first filter 52a and the second filter 52b with another metal material. Further, the spacer 52c is disposed in a central portion of the filter 52 in the axial direction. Note that the spacer 52c may be disposed at a position other than the central portion in the axial direction as long as the space 56 can be maintained at the predetermined thickness. Further, as illustrated in FIG. 4, at a stage before the first filter 52a, the spacer 52c, and the second filter 52b become a laminate, the spacer 52c can be separated in the layering direction (radial direction) from the first filter material 52a and the second filter material 52b, and the filter portion 52 may be assembled into the laminate in a state of being interposed between both filters.

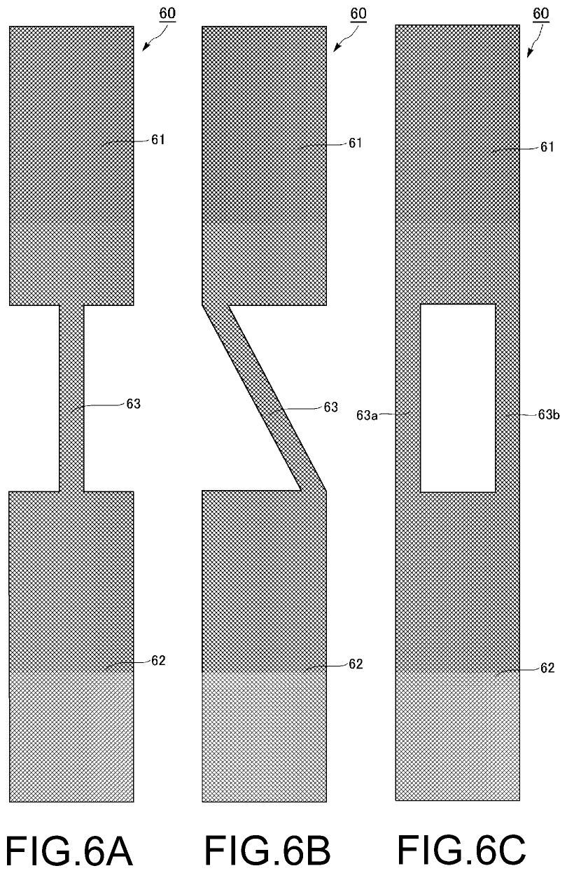

Next, a method of manufacturing the filter 52 according to the present example will be described. FIG. 6(a) is a plan view of a filter material 60 used in the manufacture of the filter 52 according to the present example. For the filter material 60, a stainless steel flat wire mesh, a lath metal, or an expanded metal is used. The filter material 60 includes a first filter material 61 and a second filter material 62. The first filter material 61 and the second filter material 62 have a rectangular sheet shape. The first filter material 61 and the second filter material 62 have the same thickness. The first filter material 61 becomes the first filter 52a and the second filter material 62 becomes the second filter 52b. Therefore, the second filter material 62 that becomes the second filter 52b disposed on the outer side has a longer length in the longitudinal direction than that of the first filter material 61 that becomes the first filter 52a. In the present example, the filter 52 illustrated in FIG. 6(a) is manufactured by compressing, in the radial direction and the axial direction, the filter material 60 wound into a cylindrical shape from an end side of the first filter material 61 in the direction of the second filter material 62.

Further, a strip portion 63 that connects the first filter material 61 and the second filter material 62 is disposed between the first filter material 61 and the second filter material 62. The strip portion 63 has the same thickness as that of the first filter 61 and the second filter material 62 and has a rectangular shape narrower than that of the first filter 61 and the second filter material 62. The strip portion 63 serves as the spacer 52c. The first filter material 61, the second filter material 62, and the strip portion 63 may be integrally formed. In this case, the strip portion 63 may be formed by cutting a portion of a filter material having a rectangular shape with a punch press or the like. Further, the first filter material 61, the second filter material 62, and the strip portion 63 may be separately formed and subsequently welded.

Further, in the present example, the filter material 60 illustrated in FIGS. 6(b) and 6(c) can be used. FIGS. 6(b) and 6(c) are plan views of the filter material 60 similar to that of FIG. 6(a). As illustrated in FIG. 6(b), the strip portion 63 may be formed extending in an oblique direction when viewed in the longitudinal direction of the filter material 60. Further, as illustrated in FIG. 6(c), a plurality of strip portions may be formed. As illustrated in FIG. 6(c), strip portions 63a, 63b are formed on both ends of the filter material 60 in the width direction. A filter assembled by the filter material 60 illustrated in FIG. 6(c) is configured with a spacer at both ends in the axial direction as illustrated in FIG. 4. That is, a flat plate material having a predetermined width and made from a metal wire mesh sheet, a lath metal sheet, an expanded metal sheet, and a perforated metal sheet is prepared in which the strip portion 63 having a width narrower than the predetermined width is disposed between the first filter material 61 and the second filter material 62 extending in the same direction. Then, the laminate having a cylindrical shape is formed by winding the laminate from an end on the side of the second filter material 62 toward the first filter 61 in multiple layers. At this time, one or a plurality of the strip portions 63 may be present in the extending direction of the first filter material 61 and the second filter material, or a plurality of the strip portions 63 may be present in a direction different from the extending direction.

The filter 52 according to the present example includes the space 56, making it possible to reduce the flow rate of the combustion gas flowing into the second filter 52b. As a result, the filter 52 can suppress the outflow of the combustion residue once collected by the second filter 52b to the outside of the filter portion 52. Furthermore, even if the combustion residue once collected by the first filter 52a passes through the first filter 52a and flows to the space 56, the flow rate of the combustion gas in the space 56 is reduced, making it possible to collect this combustion residue by the second filter 52b. In this way, the filter 52 according to the present example can suppress the outflow of combustion residue to the outside of the filter.

### Fifth Example

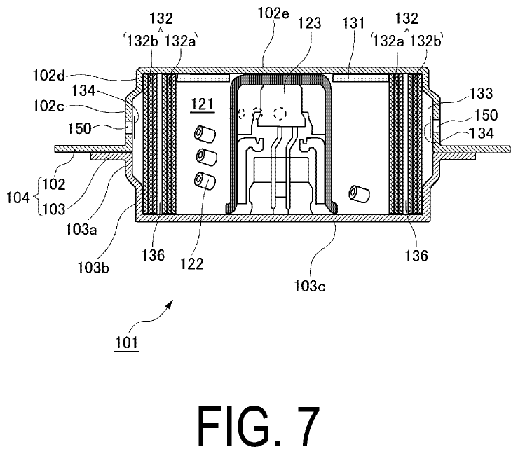

Next, a gas generator 101 of a fifth example will be described using FIG. 7. FIG. 7 is a cross-sectional view in a height direction of the gas generator 101 according to the present example. The gas generator 101 illustrated in FIG. 7 is configured as a single-type gas generator in which only one combustion chamber 121 and one igniter 123 are accommodated inside a housing 104 that includes an upper shell 102 and a lower shell 103 and is formed by being fixed by welding at a flange portion.

The upper shell 102 includes a large diameter peripheral wall 102c, a small diameter peripheral wall 102d, and a top surface 102e, which form an internal space having a concave shape. The top surface 102e, together with a bottom surface 103c of the lower shell 103 described later, has a substantially circular shape in a top view. The large diameter peripheral wall 102c and the small diameter peripheral wall 102d surround a periphery of the top surface 102e, and form a wall surface having an annular shape and extending substantially perpendicularly from the top surface 102e. The top surface 102e is connected to a first end side (upper side in FIG. 7) of the small diameter peripheral wall 102d, and the large diameter peripheral wall 102c having a diameter greater than that of the small diameter peripheral wall 102d is connected to a second end side (lower side in FIG. 7) thereof. Then, a second end side (lower side in FIG. 7) of the large diameter peripheral wall 102c serves as an opening of the upper shell 102.

The lower shell 103 includes a large diameter peripheral wall 103a, a small diameter peripheral wall 103b, and the bottom surface 103c, which form an internal space having a concave shape. The large diameter peripheral wall 103a and the small diameter peripheral wall 103b surround a periphery of the bottom surface 103c, and form a wall surface having an annular shape and extending substantially perpendicularly from the bottom surface 103c. A first end side (upper side in FIG. 7) of the large diameter peripheral wall 103a serves as an opening of the lower shell 3, and the small diameter peripheral wall 103b having a diameter less than that of the large diameter peripheral wall 103a is connected to a second end side (lower side in FIG. 7) thereof. Then, the bottom surface 103c is connected to the second end side (lower side in FIG. 7) of the small diameter peripheral wall 103b. Here, the inner diameter of the large diameter peripheral wall 103a of the lower shell 103 is substantially the same as the inner diameter of the large diameter peripheral wall 102c of the upper shell 102, and the inner diameter of the small diameter peripheral wall 103b of the lower shell 103 is substantially the same as the inner diameter of the small diameter peripheral wall 102d of the upper shell 102.

The igniter 123 is disposed in a central portion of an internal space of the housing 104. The gas generator 101 according to the present example includes the igniter 123 as an ignition device. The ignition device may be constituted by the igniter 123 only, or may be configured to include the igniter 123 and the transfer charge. As the transfer charge, a transfer charge similar to that of the first example described above can be used. Further, a lower end of the igniter 123 is joined to the bottom surface 103c of the lower shell 103, and an upper end of the igniter 123 comes into contact with a top surface of an inner cylindrical member having a cup shape disposed in an interior of the housing 104. However, the upper end of the igniter 123 need not necessarily come into contact with the top surface. Thus, the combustion chamber 121 which is a space having an annular shape and surrounding the igniter 123 is formed in the internal space of the housing 104. The combustion chamber 121 is filled with a gas generating agent 122. A similar agent as the first gas generating agent 22 illustrated in FIG. 1 is used for the gas generating agent 122.

A plurality of gas discharge ports 150 configured to discharge combustion gas generated by the combustion of the gas generating agents 122 to the outside are provided in the large diameter peripheral wall 102c in the circumferential direction of the large diameter peripheral wall 102c. Each gas discharge port 105 communicates the inside with the outside of the housing 104. Further, to prevent moisture from entering the housing 104 from the outside, before actuation of the gas generator 101, the gas discharge port 150 is closed by an aluminum tape 134 from the interior of the housing 4.

Further, the gas generator 101 is disposed between the first combustion chamber 121 and the gas discharge ports 150, and includes a filter portion 132 formed of a metal material and configured to filter the combustion gas. The filter portion 132 has the same shape and configuration as those of the filter portion 32 in the first example described above. That is, the filter portion 132 has a cylindrical shape open on both sides in the axial direction as a whole, is disposed in the housing 104, and thus includes the combustion chamber 121 in the interior of the cylindrical shape. The filter portion 132 includes a first filter 132a disposed on a side of the combustion chamber 121 and a second filter 132b disposed on a side of the gas discharge port 150 and facing the first filter 132a. The first filter 132a is cylindrical and disposed including the combustion chamber 121 in an interior thereof. The second filter 132b is cylindrical and disposed sandwiching a space 136 and including the first filter 132a in an interior thereof. The first filter 132a and the second filter 132b are interposed between the top surface 102e (corresponding to “first wall”) and a bottom surface 103c (corresponding to “second wall”) that face each other from both sides in the axial direction. Therefore, the combustion gas generated in the combustion chamber 121 passes through the first filter 132a and the second filter 132b, and then reaches the gas discharge port 150. The first filter 132a and the second filter 132b are formed of the same material as that of the first filter 32a and the second filter 32b.

Further, a cushion member 131 is disposed in the combustion chamber 121. The cushion member 131 is formed of a material that elastically deforms or plastically deforms, and imparts a biasing force to the gas generating agent 122 filled in the combustion chamber 121. The cushion member 131 used is identical to the cushion members 31, 35 illustrated in FIG. 1. The gas generating agent 122 is filled in a state of being pressed to the filter 132, the bottom surface 103c, and the like by the biasing force of the cushion member 131 and thus does not vibrate unnecessarily inside the combustion chamber 121.

The gas generator 101 according to the present example includes the space 136, making it possible to reduce the flow rate of the combustion gas flowing into the second filter 132b. As a result, the gas generator 101 reduces the flow rate of the combustion gas in the space 136 even when the pressure loss inside the first filter 132a increases, making it possible to suppress the outflow of combustion residue to the outside of the filter portion 132.

Note that the gas generators according to the examples and the modified examples described above have a disc shape in which a length in the axial direction (height direction) is shorter than an outer diameter in a top view. However, for example, the technique of the present disclosure may be applied to a gas generator having a cylindrical shape in which the length in the axial direction is longer than the outer diameter in a top view.

### REFERENCE SIGNS LIST

1, 101 Gas generator
2, 102 Upper shell
3, 103 Lower shell
4, 104 Housing
5, 150 Gas discharge port
10 Divider wall
14 Dividing wall
16 Accommodating wall member
21 First combustion chamber
22 First gas generating agent
23 First igniter
25 Second combustion chamber
26 Second gas generating agent
27 Second igniter
31, 35 Cushion
32, 52, 132 Filter
32a, 52a, 132a First filter
32b, 52b, 132b Second filter
32c, 52c, 132c Spacer
36, 56, 136 Space

1.-9. (canceled)

10. A gas generator, comprising:
a housing;
an ignition device accommodated in the housing;
a combustion chamber filled with a gas generating agent burned by actuation of the ignition device and provided in the housing;
a gas discharge port configured to discharge combustion gas generated by combustion of the gas generating agent to an outside; and
a filter portion disposed between the combustion chamber and the gas discharge port, formed of a metal material, and configured to filter the combustion gas;
the filter portion including,
a first filter disposed on a side of the combustion chamber, and
a second filter disposed on a side of the gas discharge port and facing the first filter, and
a space being provided between the first filter and the second filter, so as to include a position where the combustion gas flows and to have a predetermined thickness in a direction of flow of the combustion gas, causing a flow rate of the combustion gas flowing into the second filter to decrease due to absence of the metal material therein.

11. The gas generator according to claim 10, wherein
the first filter is cylindrical and disposed including the combustion chamber in an interior thereof,
the second filter is cylindrical and disposed sandwiching the space and including the first filter in an interior thereof, and
the first filter and the second filter are interposed between a first wall and a second wall facing each other from opposite sides in an axial direction.

12. The gas generator according to claim 11, wherein
the space is positioned including at least an area between a first imaginary straight line connecting a gas generating agent near the first wall inside the combustion chamber and the gas discharge port, and a second imaginary straight line connecting a gas generating agent near the second wall inside the combustion chamber and the gas discharge port.

13. The gas generator according to claim 11, wherein
the space is formed enclosed by the first filter, the second filter, the first wall, and the second wall.

14. The gas generator according to claim 12, wherein
the space is formed enclosed by the first filter, the second filter, the first wall, and the second wall.

15. The gas generator according to claim 10, wherein
the first filter and the second filter are formed by layering a filter material having a same thickness across a plurality of layers in the direction of flow of the combustion gas and
a thickness of the space is greater than or equal to a thickness of one layer of the filter material.

16. The gas generator according to claim 11, wherein
the first filter and the second filter are formed by layering a filter material having a same thickness across a plurality of layers in the direction of flow of the combustion gas and
a thickness of the space is greater than or equal to a thickness of one layer of the filter material.

17. The gas generator according to claim 12, wherein
the first filter and the second filter are formed by layering a filter material having a same thickness across a plurality of layers in the direction of flow of the combustion gas and
a thickness of the space is greater than or equal to a thickness of one layer of the filter material.

18. The gas generator according to claim 13, wherein
the first filter and the second filter are formed by layering a filter material having a same thickness across a plurality of layers in the direction of flow of the combustion gas and
a thickness of the space is greater than or equal to a thickness of one layer of the filter material.

19. The gas generator according to claim 10, wherein
the filter portion includes a spacer interposed between the first filter and the second filter and configured to maintain the space at the predetermined thickness.

20. The gas generator according to claim 11, wherein
the filter portion includes a spacer interposed between the first filter and the second filter and configured to maintain the space at the predetermined thickness.

21. The gas generator according to claim 12, wherein
the filter portion includes a spacer interposed between the first filter and the second filter and configured to maintain the space at the predetermined thickness.

22. The gas generator according to claim 13, wherein
the filter portion includes a spacer interposed between the first filter and the second filter and configured to maintain the space at the predetermined thickness.

23. The gas generator according to claim 14, wherein
the filter portion includes a spacer interposed between the first filter and the second filter and configured to maintain the space at the predetermined thickness.

24. The gas generator according to claim 19, wherein
the first filter, the second filter, and the spacer are integrally formed of the metal material.

25. The gas generator according to claim 10, wherein
a mesh opening of the second filter is smaller than a mesh opening of the first filter.

26. A filter for a gas generator including,
a housing,
an ignition device accommodated in the housing,
a combustion chamber filled with a gas generating agent burned by actuation of the ignition device and provided in the housing, and
a gas discharge port configured to discharge combustion gas generated by combustion of the gas generating agent to an outside,
the filter being disposed between the combustion chamber and the gas discharge port, formed of a metal material, configured to filter the combustion gas, and comprising:
a first filter disposed on a side of the combustion chamber;
a second filter disposed on a side of the gas discharge port and facing the first filter;
a space being provided between the first filter and the second filter, so as to include a position where the combustion gas flows and to have a predetermined thickness in a direction of flow of the combustion gas, causing a flow rate of the combustion gas flowing into the second filter to decrease due to absence of the metal material therein when disposed in the housing; and
a spacer interposed between the first filter and the second filter and configured to maintain the space at the predetermined thickness.
